(19) United States
(12) Patent Application Publication
(10) Pub. No.: US 2023/0387807 A1
(43) Pub. Date: Nov. 30, 2023

(54) CHARGING CIRCUIT AND CHARGING APPARATUS

(71) Applicant: Huawei Digital Power Technologies Co., Ltd., Shenzhen (CN)

(72) Inventors: Yang LIU, Shenzhen (CN); Jixin ZHU, Dongguan (CN); Biao HU, Shenzhen (CN)

(21) Appl. No.: 18/229,960

(22) Filed: Aug. 3, 2023

Related U.S. Application Data
(63) Continuation of application No. PCT/CN2021/075577, filed on Feb. 5, 2021.

(51) Int. Cl. H02M 3/335; B60L 53/22

(52) U.S. Cl. CPC H02M 3/335; B60L 53/22; B60L 2210/10

(57) ABSTRACT

A charging circuit includes at least two groups of DC/DC converters, at least one group of relay switches, and at least one diode that are mutually coupled. The relay switch is configured to connect the at least two groups of DC/DC converters in series when a first voltage is in a first threshold range. The first voltage is a charging voltage of an electric vehicle. The relay switch is further configured to connect the at least two groups of DC/DC converters in parallel when the first voltage is in a second threshold range. The diode is configured to prevent a current of a storage battery in the electric vehicle from flowing back. In embodiments of this application, a volume of a charging apparatus can be reduced.

### CROSS-REFERENCE TO RELATED APPLICATIONS

This application is a continuation of International Application No. PCT/CN2021/075577, filed on Feb. 5, 2021, the disclosure of which is hereby incorporated by reference in its entirety.

### TECHNICAL FIELD

Embodiments of this application relate to the field of electronic circuit technologies, and in particular, to a charging circuit and a charging apparatus.

### BACKGROUND

Currently, different types of electric vehicles have different charging voltage ranges. For example, usually, a charging voltage range of a passenger vehicle is from 200 V to 500 V, and a charging voltage range of a bus is from 300 V to 750 V. A charging apparatus needs to meet both a fast charging requirement of the passenger vehicle and a fast charging requirement of the bus. The charging apparatus needs to meet wide range output because of different charging voltage ranges. In an energy industry standard NB/T 33001-2018 of the People's Republic of China, it is specified that the charging apparatus needs to have an anti-backflow function (for example, a diode is added to output end), to prevent a current of a storage battery from flowing back. Therefore, the charging apparatus further needs to meet an anti-backflow requirement.

Because the charging apparatus needs to meet both the wide range output and the anti-backflow requirement, usually, a switch circuit may be used to control a conversion circuit to implement the wide range output, and an anti-backflow circuit is added to an output port to prevent the current of the storage battery from flowing back. In an existing solution, the wide range output and anti-backflow may be implemented. However, there are a large quantity of components in a circuit, and consequently, the charging apparatus has a large volume.

### SUMMARY

Embodiments of this application provide a charging circuit and a charging apparatus, to reduce a volume of the charging apparatus.

A first aspect provides a charging circuit. The charging circuit may include at least two groups of direct current (DC)/DC converters, at least one group of relay switches, and at least one diode that are mutually coupled. The relay switch is configured to connect the at least two groups of DC/DC converters in series when a first voltage is in a first threshold range. The first voltage is a charging voltage of an electric vehicle. The relay switch is further configured to connect the at least two groups of DC/DC converters in parallel when the first voltage is in a second threshold range. The diode is configured to prevent a current of a storage battery in the electric vehicle from flowing back.

In the solution provided in this application, the DC/DC converter may convert a first direct current into a second direct current, and the second direct current is configured to supply power to the storage battery in the electric vehicle. For electric vehicles with different charging voltage ranges, the at least two groups of DC/DC converters implement wide range voltage output by using the relay switch, to meet charging requirements of different electric vehicles. In addition, the diode may be used to prevent the current of the storage battery in the electric vehicle from flowing back. Different from the conventional technology in which there are a large quantity of components in a charging circuit, and consequently, a charging apparatus has a large volume, in the technical solution in this application, a small quantity of components are used for the charging circuit, to meet wide voltage output and an anti-backflow requirement of the charging circuit, to reduce a volume of the charging apparatus, improve power density of a charging apparatus product, and reduce costs of the charging apparatus.

In an embodiment, when the charging circuit includes two groups of DC/DC converters and one group of relay switches, the charging circuit includes a first DC/DC converter, a second DC/DC converter, a first relay switch, a first diode, a second diode, and a third diode. A cathode of the first diode is coupled to a first output end of the first DC/DC converter by using the first relay switch, a anode of the first diode is coupled to a first output end of the second DC/DC converter, a cathode of the second diode is coupled to the first output end of the first DC/DC converter, a anode of the second diode is coupled to a second output end of the second DC/DC converter, a cathode of the third diode is coupled to a second output end of the first DC/DC converter, a anode of the third diode is coupled to the first output end of the second DC/DC converter, the second output end of the first DC/DC converter is a first output end of the charging circuit, and the second output end of the second DC/DC converter is a second output end of the charging circuit.

In the solution provided in this application, the charging circuit may include at least two groups of DC/DC converters, at least one group of relay switches, and at least one diode. When the charging circuit includes two groups of DC/DC converters and one group of relay switches, a possible connection manner may be connecting the two groups of DC/DC converters, the one group of relay switches, and three diodes. In this way, wide voltage output and an anti-backflow requirement can be met by using only one group of relay switches, to reduce a volume of a charging apparatus.

In an embodiment, the charging circuit further includes a control circuit. The control circuit is configured to: when the first voltage is in the first threshold range, control the first relay switch to connect the first DC/DC converter and the second DC/DC converter in series, and when the first voltage is in the second threshold range, control the first relay switch to connect the first DC/DC converter and the second DC/DC converter in parallel.

In the solution provided in this application, when the electric vehicle needs to be charged, the control circuit may identify a charging voltage range of the electric vehicle through communication, and control closing or opening of the first relay switch based on the identified charging voltage range of the electric vehicle, so that the first DC/DC converter and the second DC/DC converter are connected in series or in parallel, to output voltages in different ranges.

In an embodiment, when the charging circuit includes two groups of DC/DC converters and two groups of relay switches, the charging circuit includes a first DC/DC converter, a second DC/DC converter, a first relay switch, a second relay switch, a first diode, a second diode, and a third diode. A cathode of the first diode is coupled to a first output end of the first DC/DC converter, a anode of the first diode is coupled to a first output end of the second DC/DC converter, a cathode of the second diode is coupled to the first output end of the first DC/DC converter by using the first relay switch, a anode of the second diode is coupled to a second output end of the second DC/DC converter, a cathode of the third diode is coupled to a second output end of the first DC/DC converter by using the second relay switch, a anode of the third diode is coupled to the first output end of the second DC/DC converter, the second output end of the first DC/DC converter is a first output end of the charging circuit, and the second output end of the second DC/DC converter is a second output end of the charging circuit. The first relay switch and the second relay switch are open, so that the first DC/DC converter and the second DC/DC converter are connected in series; and the first relay switch and the second relay switch are closed, so that the first DC/DC converter and the second DC/DC converter are connected in parallel.

In the solution provided in this application, the charging circuit may include at least two groups of DC/DC converters, at least one group of relay switches, and at least one diode. When the charging circuit includes two groups of DC/DC converters and two groups of relay switches, a possible connection manner may be connecting the two groups of DC/DC converters, the two groups of relay switches, and three diodes. In this way, wide voltage output and an anti-backflow requirement can be met by using only two groups of relay switches, to reduce a volume of a charging apparatus.

In an embodiment, the charging circuit further includes a control circuit. The control circuit is configured to: when the first voltage is in the first threshold range, control the first relay switch and the second relay switch to connect the first DC/DC converter and the second DC/DC converter in series, and when the first voltage is in the second threshold range, control the first relay switch and the second relay switch to connect the first DC/DC converter and the second DC/DC converter in parallel.

In the solution provided in this application, when the electric vehicle needs to be charged, the control circuit may identify a charging voltage range of the electric vehicle through communication, and control closing or opening of the first relay switch and the second relay switch based on the identified charging voltage range of the electric vehicle, so that the first DC/DC converter and the second DC/DC converter are connected in series or in parallel, to output voltages in different ranges.

In an embodiment, when the first relay switch is an alternating current relay switch, the charging circuit further includes a first semiconductor device. The first relay switch is coupled to the first semiconductor device in parallel; and the first semiconductor device is configured to protect the first relay switch.

In the solution provided in this application, when the charging circuit includes one group of relay switches, the first relay switch may be an alternating current relay switch. Because the alternating current relay switch has a small volume and low costs, a volume of a charging apparatus can be reduced, and costs of the charging apparatus can also be reduced. However, a single-point fault occurs when a direct current flows through the alternating current relay switch. Therefore, a semiconductor device needs to be coupled to the first relay switch in parallel. The semiconductor device may protect the first relay switch, to prevent the first relay switch from generating an arc and being damaged.

In an embodiment, when the first relay switch is an alternating current relay switch and the second relay switch is an alternating current relay switch, the charging circuit further includes a first semiconductor device and a second semiconductor device. The first relay switch and the second relay switch are respectively coupled to the first semiconductor device and the second semiconductor device in parallel. The first semiconductor device is configured to protect the first relay switch; and the second semiconductor device is configured to protect the second relay switch.

In the solution provided in this application, when the charging circuit includes two groups of relay switches, the first relay switch may be an alternating current relay switch, and the second relay switch may be an alternating current relay switch. Because the alternating current relay switch has a small volume and low costs, a volume of a charging apparatus can be reduced, and costs of the charging apparatus can also be reduced. However, a single-point fault occurs when a direct current flows through the alternating current relay switch. Therefore, a semiconductor device needs to be coupled to the first relay switch in parallel, and a semiconductor device needs to be coupled to the second relay switch in parallel. The semiconductor device may protect the relay switch, to prevent the relay switch from generating an arc and being damaged.

In an embodiment, the first semiconductor device is any one of an insulated gate bipolar transistor (IGBT), a metal-oxide-semiconductor field-effect transistor (MOSFET), and a silicon controlled rectifier (SCR).

In an embodiment, the second semiconductor device is any one of an IGBT, a MOSFET, and an SCR.

In an embodiment, a circuit structure of each of the first DC/DC converter and the second DC/DC converter is any one of the following types: a full-bridge inductor-inductor-capacitor (LLC) resonant circuit, a half-bridge LLC resonant circuit, a three-level LLC resonant circuit, a three-level full-bridge circuit, a phase-shift full-bridge circuit, an asymmetric half-bridge circuit, and a three-phase interleaved LLC resonant circuit.

A second aspect provides a charging apparatus. The charging apparatus may include the charging circuit provided in the first aspect and any implementation of the first aspect.

### BRIEF DESCRIPTION OF DRAWINGS

FIG. 1 is a schematic diagram of an application scenario according to an embodiment of this application;

FIG. 2 is a schematic diagram of a charging voltage of a charging station of an electric vehicle in the conventional technology;

FIG. 3 is a schematic diagram of a structure of a charging circuit according to an embodiment of this application;

FIG. 4 is a schematic diagram of a structure of another charging circuit according to an embodiment of this application;

FIG. 5 is a schematic diagram of a structure of still another charging circuit according to an embodiment of this application;

FIG. 6 is a schematic diagram of a structure of yet another charging circuit according to an embodiment of this application;

FIG. 7 is a schematic diagram of a structure of still yet another charging circuit according to an embodiment of this application;

FIG. 8 is a schematic diagram of a structure of a further charging circuit according to an embodiment of this application;

FIG. 9 is a schematic diagram of a structure of a still further charging circuit according to an embodiment of this application;

FIG. 10 is a schematic diagram of a structure of a yet further charging circuit according to an embodiment of this application;

FIG. 11 to FIG. 17 are schematic diagrams of structures of several DC/DC converters according to an embodiment of this application; and

FIG. 18 is a schematic diagram of a charging apparatus according to an embodiment of this application.

### DESCRIPTION OF EMBODIMENTS

Embodiments of this application provide a charging circuit and a charging apparatus, to reduce a volume of the charging apparatus. The following describes in detail the technical solutions in embodiments of this application with reference to the accompanying drawings in embodiments of this application. It is clearly that the described embodiments are merely some but not all of embodiments of this application.

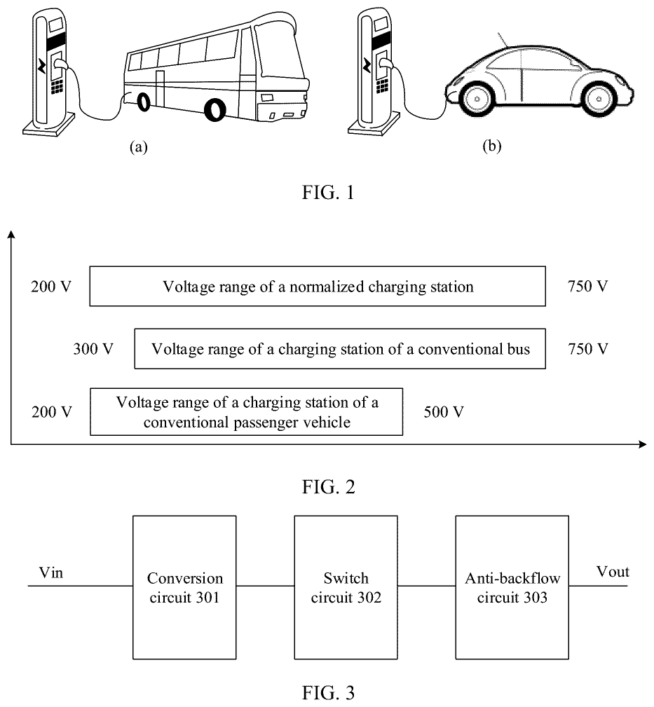

To better understand the charging circuit and the charging apparatus provided in embodiments of this application, the following first describes an application scenario of embodiments of this application. FIG. 1 is a schematic diagram of an application scenario according to an embodiment of this application. As shown in FIG. 1, a conventional charging system includes a charging station of a passenger vehicle in (b) in FIG. 1 and a charging station of a bus in (a) in FIG. 1. Usually, a charging voltage range of the passenger vehicle is from 200 V to 500 V, and a charging voltage range of the bus is from 300 V to 750 V. In recent years, the charging system tends to develop towards a higher charging voltage. In this background, the charging apparatus may implement charging normalization. FIG. 2 is a schematic diagram of a charging voltage of a charging station of an electric vehicle in the conventional technology. As shown in FIG. 2, a normalized charging apparatus may meet a full range constant power requirement. For example, the normalized charging apparatus can meet both a fast charging requirement of the passenger vehicle and a fast charging requirement of the bus. Two typical constant power requirements are constant power output at an output voltage (from 250 V to 500 V) and constant power output at an output voltage (from 500 V to 1000 V).

To implement high-power fast charging of a direct current charging pile, all current mainstream charging pile device manufacturers in this industry connect a plurality of single-unit charging modules in parallel, to form a high-power charging cabinet. A typical total output power of charging piles that are connected in parallel is 60 kW, 90 kW, or 120 kW. If an output power of each module is 15 kW, there are respectively four/six/eight single-unit charging pile modules in the cabinet of the charging pile; or if an output power of each module is 30 kW, there are respectively two/three/four single-unit charging pile modules in the cabinet of the charging pile. In an energy industry standard NB/T 33001-2018 of the People's Republic of China, it is specified that the charging apparatus needs to have an anti-backflow function, to prevent a current of a storage battery from flowing back. To ensure that a plurality of modules that operate in parallel can operate reliably, especially in consideration of an anti-backflow requirement of output, an anti-backflow diode is usually added to output of the charging module.

In an existing solution, a charging circuit can meet a highly efficient wide voltage range and a reliable anti-backflow requirement. The charging circuit may include a conversion circuit, a switch circuit, and an anti-backflow circuit. In consideration of a wide range constant power requirement, to obtain high efficiency, the switch circuit is used to control the conversion circuit to implement wide range output. In consideration of the anti-backflow requirement, the anti-backflow circuit may be added to an output port of the charging circuit. In an existing solution, there are a large quantity of components in the circuit, and consequently, the charging apparatus has a large volume and high costs.

To resolve the foregoing problems, this application provides a charging circuit and a charging apparatus. The following describes the charging circuit in detail. FIG. 3 is a schematic diagram of a structure of a charging circuit according to an embodiment of this application. As shown in FIG. 3, the charging circuit may include a conversion circuit 301, a switch circuit 302, and an anti-backflow circuit 303. The switch circuit 302 is separately coupled to the conversion circuit 301 and the anti-backflow circuit 303. The switch circuit 302 is configured to control the conversion circuit 301 to implement wide range output, and the anti-backflow circuit 303 is configured to prevent a current from flowing back.

The conversion circuit 301 includes at least two groups of DC/DC converters that are mutually coupled. The at least two groups of DC/DC converters are configured to convert a first direct current into a second direct current. A voltage of the second direct current is a first voltage, and the charging circuit supplies power to a storage battery in an electric vehicle by using the second direct current. The DC/DC converter is a voltage converter that converts an input voltage and then effectively outputs a fixed voltage.

The switch circuit 302 includes at least one group of relay switches. The at least one group of relay switches is configured to connect the at least two groups of DC/DC converters in series when the first voltage is in a first threshold range. The first voltage is a charging voltage of the electric vehicle. The relay switch is further configured to connect the at least two groups of DC/DC converters in parallel when the first voltage is in a second threshold range.

The anti-backflow circuit 303 includes at least one diode. The at least one diode is configured to prevent a current of the storage battery in the electric vehicle from flowing back.

It can be understood that, in an embodiment of the application, one group of relay switches may be one relay switch, or may be a plurality of relay switches. The group of relay switches implement a same function, and are closed/open, to control a connection/disconnection of the circuit. Similarly, one group of DC/DC converters may be one DC/DC converter, or may be a plurality of DC/DC converters. The group of DC/DC converters implement a same function. This is not limited in this application.

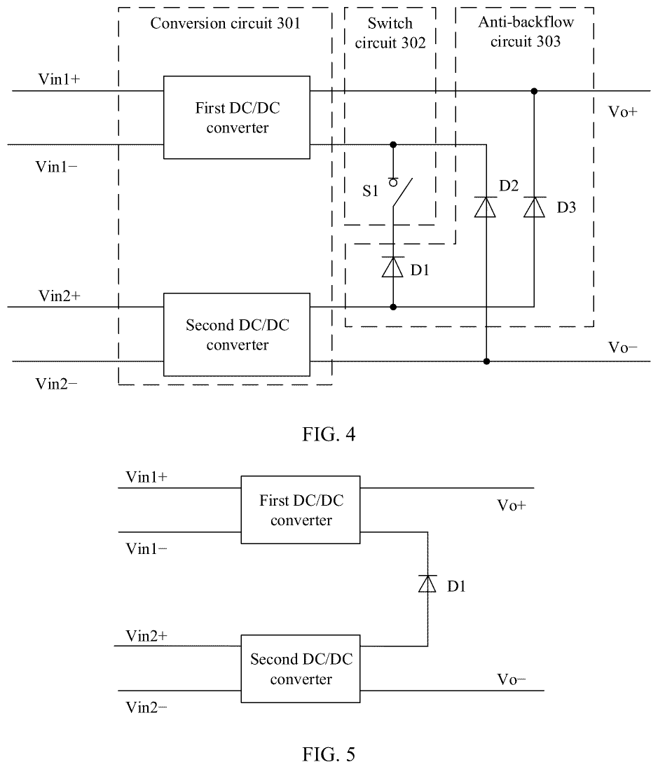

FIG. 4 is a schematic diagram of a structure of another charging circuit according to an embodiment of this application. The charging circuit shown in FIG. 3 is optimized in FIG. 4. As shown in FIG. 4, the charging circuit includes a conversion circuit 301, a switch circuit 302, and an anti-backflow circuit 303. When the conversion circuit 301 includes two groups of DC/DC converters, and the switch circuit 302 includes one group of relay switches, for example, the conversion circuit 301 includes a first DC/DC converter and a second DC/DC converter, the switch circuit 302 includes a first relay switch S1, and the anti-backflow circuit 303 includes a first diode D1, a second diode D2, and a third diode D3.

Input voltages of the first DC/DC converter and the second DC/DC converter may be a same voltage, or may be different voltages. A cathode of D1 is coupled to a first output end of the first DC/DC converter by using S1, a anode of D1 is coupled to a first output end of the second DC/DC converter, a cathode of D2 is coupled to the first output end of the first DC/DC converter, a anode of D2 is coupled to a second output end of the second DC/DC converter, a cathode of D3 is coupled to a second output end of the first DC/DC converter, a anode of D3 is coupled to the first output end of the second DC/DC converter, the second output end of the first DC/DC converter is a first output end of the charging circuit, and the second output end of the second DC/DC converter is a second output end of the charging circuit.

In an embodiment, FIG. 5 is a schematic diagram of a structure of still another charging circuit according to an embodiment of this application. As shown in FIG. 5, when S1 is closed, a first DC/DC converter and a second DC/DC converter are connected in series.

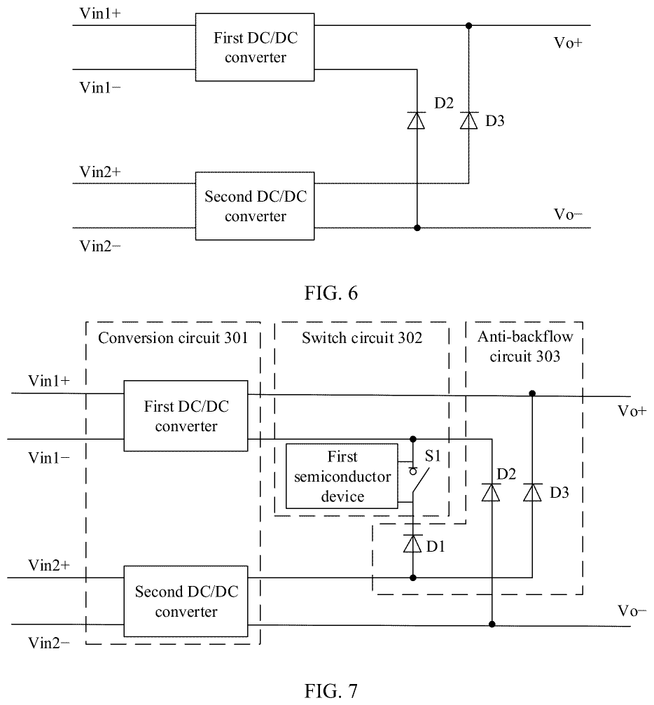

FIG. 6 is a schematic diagram of a structure of yet another charging circuit according to an embodiment of this application. As shown in FIG. 6, when S1 is open, a first DC/DC converter and a second DC/DC converter are connected in parallel.

In an embodiment, S1 may be an alternating current relay switch. FIG. 7 is a schematic diagram of a structure of still yet another charging circuit according to an embodiment of this application. The charging circuit shown in FIG. 4 is optimized in FIG. 7. As shown in FIG. 7, when S1 is an alternating current relay switch, a switch circuit 302 in the charging circuit may further include a first semiconductor device. S1 is coupled to the first semiconductor device in parallel, and the first semiconductor device is configured to protect S1. A single-point fault occurs because a direct current flows through an alternating current relay. Because the first semiconductor device is coupled to S1 in parallel, when S1 is open with a load, S1 may be prevented from generating an arc and being damaged. The arc may indicate a maximum capability of breaking a current at a limit by the relay switch.

In an embodiment, the first semiconductor device may be any one of an IGBT, a MOSFET, and an SCR.

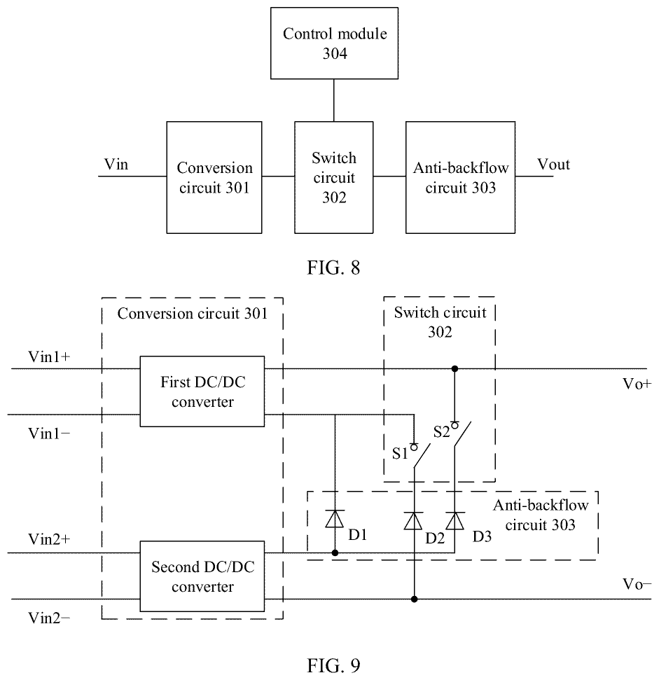

FIG. 8 is a schematic diagram of a structure of a further charging circuit according to an embodiment of this application. As shown in FIG. 8, based on the schematic diagram shown in FIG. 3, the charging circuit may further include a control circuit 304, and the control circuit 304 is coupled to a switch circuit 302.

In FIG. 4 to FIG. 7, the control circuit 304 is coupled to S1.

The control circuit 304 is configured to: when a first voltage is in a first threshold range, control S1 to connect the first DC/DC converter and the second DC/DC converter in series, and when the first voltage is in a second threshold range, control S1 to connect the first DC/DC converter and the second DC/DC converter in parallel. For example, when an electric vehicle needs to be charged, the control circuit 304 may first detect or obtain a type of the electric vehicle and a required charging voltage range, and then deliver a signal or a driving signal to the switch circuit 302 based on the charging voltage range, to control the switch circuit 302 (control opening/closing of S1), to control a conversion circuit 301 (control the first DC/DC converter and the second DC/DC converter to be connected in series/parallel), and implement wide range output. The control circuit 304 may be a circuit that includes a micro control unit (MCU) and a drive circuit. For example, the MCU delivers a signal to the drive circuit, and the drive circuit may drive opening/closing of S1.

For a detailed description of an optimization circuit corresponding to FIG. 8, refer to descriptions in FIG. 4 to FIG. 7. To avoid repetition, details are not described herein again. It can be understood that, in the charging circuits shown in FIG. 4 to FIG. 7, the conversion circuit 301 includes only two groups of DC/DC converters in an example. The conversion circuit 301 may further include a larger quantity of DC/DC converters. The conversion circuit implements a same function. A quantity of DC/DC converters in the conversion circuit 301 is not limited in an embodiment of the application. Similarly, in the charging circuits shown in FIG. 4 to FIG. 7, an anti-backflow circuit 303 includes only three diodes in an example. The anti-backflow circuit 303 may further include a larger quantity of diodes. The anti-backflow circuit implements a same function. A quantity of diodes in the anti-backflow circuit 303 is not limited in an embodiment of the application.

FIG. 9 is a schematic diagram of a structure of a still further charging circuit according to an embodiment of this application. The charging circuit shown in FIG. 3 is optimized in FIG. 9. As shown in FIG. 9, the charging circuit includes a conversion circuit 301, a switch circuit 302, and an anti-backflow circuit 303. When the conversion circuit 301 includes two groups of DC/DC converters, and the switch circuit 302 includes two groups of relay switches, for example, the conversion circuit 301 includes a first DC/DC converter and a second DC/DC converter, the switch circuit 302 includes a first relay switch S1 and a second relay switch S2, and the anti-backflow circuit 303 includes a first diode D1, a second diode D2, and a third diode D3.

Input voltages of the first DC/DC converter and the second DC/DC converter may be a same voltage, or may be different voltages. A cathode of D1 is coupled to a first output end of the first DC/DC converter, a anode of D1 is coupled to a first output end of the second DC/DC converter, a cathode of D2 is coupled to the first output end of the first DC/DC converter by using S1, a anode of D2 is coupled to a second output end of the second DC/DC converter, a cathode of D3 is coupled to a second output end of the first DC/DC converter by using S2, a anode of D3 is coupled to the first output end of the second DC/DC converter, the second output end of the first DC/DC converter is a first output end of the charging circuit, and the second output end of the second DC/DC converter is a second output end of the charging circuit.

In an embodiment, when both S1 and S2 are open, as shown in FIG. 5, the first DC/DC converter and the second DC/DC converter are connected in series; and when both S1 and S2 are closed, as shown in FIG. 6, the first DC/DC converter and the second DC/DC converter are connected in parallel.

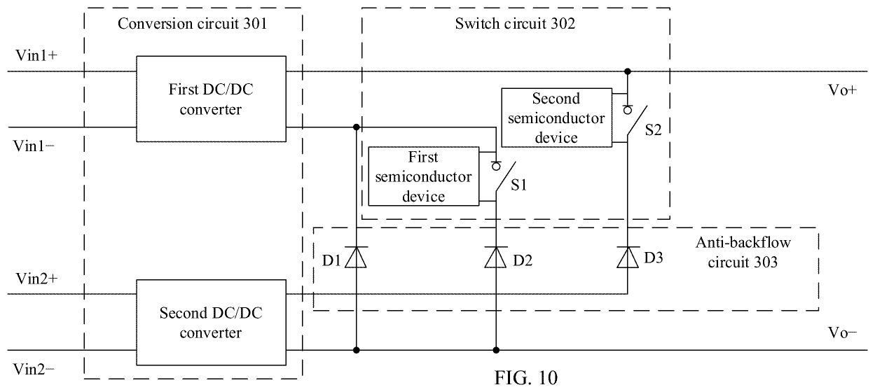

In an embodiment, S1 may be an alternating current relay switch, and S2 may also be an alternating current relay switch. FIG. 10 is a schematic diagram of a structure of a yet further charging circuit according to an embodiment of this application. The charging circuit shown in FIG. 9 is optimized in FIG. 10. As shown in FIG. 10, when S1 is an alternating current relay switch and S2 is an alternating current relay switch, a switch circuit 302 in the charging circuit may further include a first semiconductor device and a second semiconductor device. S1 and S2 are respectively coupled to the first semiconductor device and the second semiconductor device in parallel; the first semiconductor device is configured to protect S1; and the second semiconductor device is configured to protect S2. A single-point fault occurs because a direct current flows through an alternating current relay. Because the first semiconductor device is coupled to S1 and S2 in parallel, when S1 and S2 are open with a load, S1 and S2 may be prevented from generating an arc and being damaged. The arc may indicate a maximum capability of breaking a current at a limit by the relay switch.

In an embodiment, the first semiconductor device may be any one of an IGBT, a MOSFET, and an SCR; and the second semiconductor device may also be any one of an IGBT, a rMOSFET, and an SCR.

The charging circuit shown in FIG. 8 may further include a control circuit 304, and the control circuit 304 is coupled to the switch circuit 302.

In FIG. 9 and FIG. 10, the control circuit 304 is coupled to S1 and S2.

The control circuit 304 is configured to: when a first voltage is in a first threshold range, control both S1 and S2 to be open, to connect the first DC/DC converter and the second DC/DC converter in series, and when the first voltage is in a second threshold range, control both S1 and S2 to be closed, to connect the first DC/DC converter and the second DC/DC converter in parallel. For example, when an electric vehicle needs to be charged, the control circuit 304 may first detect or obtain a type of the electric vehicle and a required charging voltage range, and then deliver a signal or a driving signal to the switch circuit 302 based on the charging voltage range, to control the switch circuit 302 (control opening/closing of S1 and S2), to control the conversion circuit 301 (control the first DC/DC converter and the second DC/DC converter to be connected in series/parallel), and implement wide range output. The control circuit 304 may be a circuit that includes an MCU and a driver circuit. For example, the MCU delivers a signal to the drive circuit, and the drive circuit may drive opening/closing of S1 and/or S2.

It can be understood that, in the charging circuits shown in FIG. 9 and FIG. 10, the conversion circuit 301 includes only two groups of DC/DC converters in an example. The conversion circuit 301 may further include a larger quantity of DC/DC converters. The conversion circuit implements a same function. A quantity of DC/DC converters in the conversion circuit 301 is not limited in an embodiment of the application. Similarly, in the charging circuits shown in FIG. 9 and FIG. 10, the anti-backflow circuit 303 includes only three diodes in an example. The anti-backflow circuit 303 may further include a larger quantity of diodes. The anti-backflow circuit implements a same function. A quantity of diodes in the anti-backflow circuit 303 is not limited in an embodiment of the application.

It can be understood that the relay switch in the charging circuits shown in FIG. 4 to FIG. 10 may also be another component that can implement the same function, and the diode may also be another component that can implement the same function. This is not limited in this application.

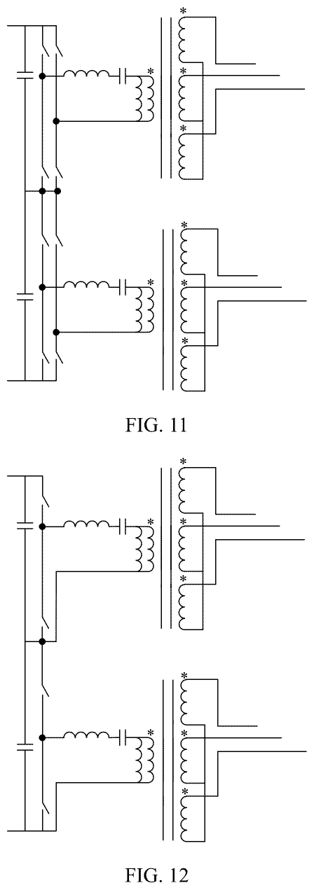

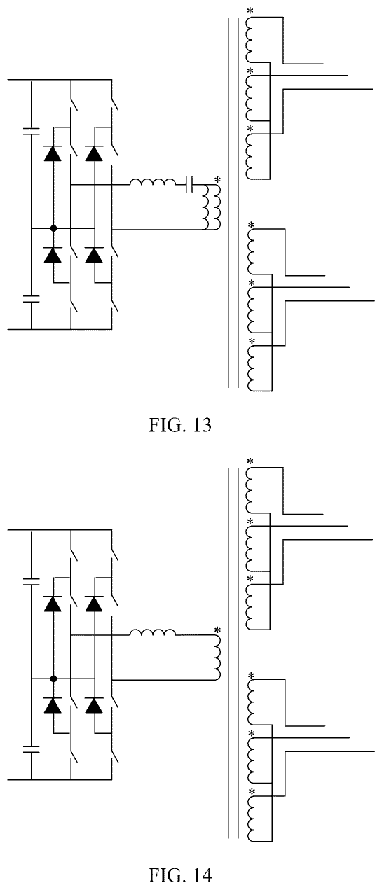

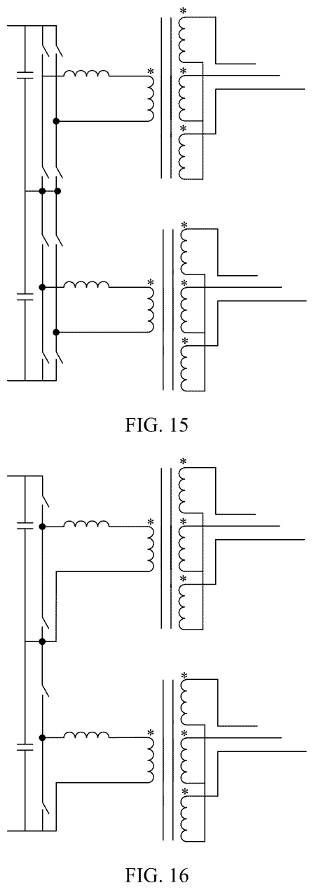

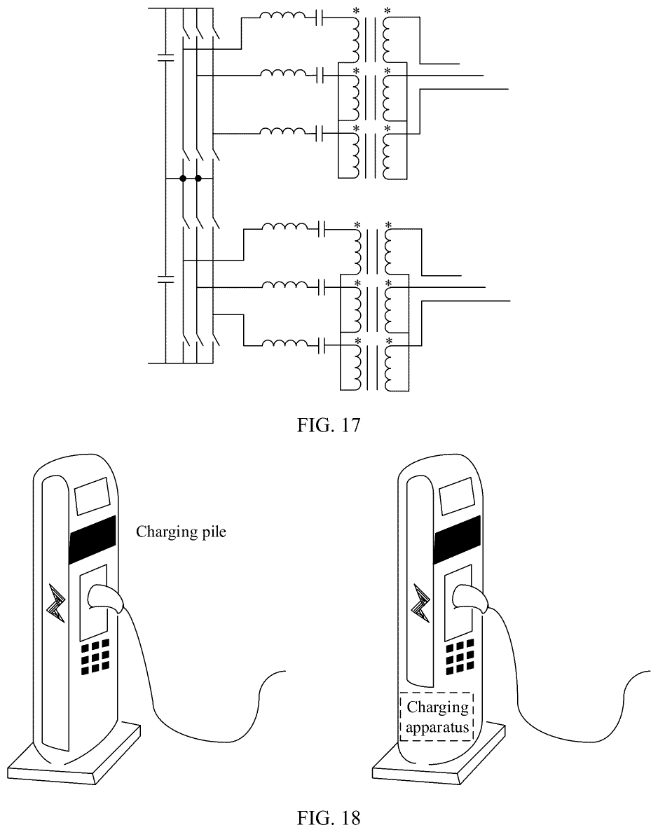

As shown in FIG. 11 to FIG. 17, for a DC/DC converter in any one of the foregoing charging circuits, a converter type of the DC/DC converter is any one of a converter with a full-bridge LLC resonant circuit shown in FIG. 11, a converter with a half-bridge LLC resonant circuit shown in FIG. 12, a converter with a three-level LLC resonant circuit shown in FIG. 13, a converter with a three-level full-bridge circuit shown in FIG. 14, a converter with a phase-shift full-bridge circuit shown in FIG. 15, a converter with an asymmetric half-bridge circuit shown in FIG. 16, and a converter with a three-phase interleaved LLC resonant circuit shown in FIG. 17.

The foregoing describes the charging circuits in embodiments of this application, and the following describes a possible product form to which the charging circuits are applied. It should be understood that any form of product to which the charging circuits in FIG. 3 to FIG. 10 are applied is in the protection scope of this application. It should be further understood that the following description is merely an example, and a product form in an embodiment of the application is not limited thereto.

A charging apparatus is a possible product form. FIG. 18 is a schematic diagram of a charging apparatus according to an embodiment of this application. As shown in FIG. 18, the charging apparatus may be a charging pile, or may be a charging module (model) in the charging pile. A name of the charging module may also be referred to as a power supply apparatus/charging unit/charger, or the like. The charging module may be obtained by perform combination through insertion/removal, or may be integrated. The charging apparatus may also be applied to an apparatus other than the charging pile.

The objectives, technical solutions, and benefits of this application are further described in detail in the foregoing embodiments. It should be understood that the foregoing descriptions are merely embodiments of this application, but are not intended to limit the protection scope of this application. Any modification, equivalent replacement or improvement made based on technical solutions of this application shall fall within the protection scope of this application.

What is claimed is:

1. A charging circuit, comprising:
at least two groups of direct current (DC)/DC converters mutually coupled,
at least one group of relay switches configured to connect the at least two groups of DC/DC converters in series when a first voltage is in a first threshold range, and configured to connect the at least two groups of DC/DC converters in parallel when the first voltage is in a second threshold range, wherein the first voltage is a charging voltage of an electric vehicle, and
at least one diode configured to prevent a current of a storage battery in the electric vehicle from flowing back.

2. The charging circuit according to claim 1, wherein when the charging circuit comprises two groups of DC/DC converters and one group of relay switches, the charging circuit comprises:
a first DC/DC converter,
a second DC/DC converter,
a first relay switch,
a first diode,
a second diode, and
a third diode, and
a cathode of the first diode is coupled to a first output end of the first DC/DC converter by using the first relay switch, a anode of the first diode is coupled to a first output end of the second DC/DC converter, a cathode of the second diode is coupled to the first output end of the first DC/DC converter, a anode of the second diode is coupled to a second output end of the second DC/DC converter, a cathode of the third diode is coupled to a second output end of the first DC/DC converter, a anode of the third diode is coupled to the first output end of the second DC/DC converter, the second output end of the first DC/DC converter is a first output end of the charging circuit, and the second output end of the second DC/DC converter is a second output end of the charging circuit.

3. The charging circuit according to claim 2, wherein the charging circuit further comprises a control circuit configured to:
when the first voltage is in the first threshold range, control the first relay switch to connect the first DC/DC converter and the second DC/DC converter in series, and
when the first voltage is in the second threshold range, control the first relay switch to connect the first DC/DC converter and the second DC/DC converter in parallel.

4. The charging circuit according to claim 1, wherein when the charging circuit comprises two groups of DC/DC converters and two groups of relay switches, the charging circuit comprises:
a first DC/DC converter,
a second DC/DC converter,
a first relay switch,
a second relay switch,
a first diode,
a second diode, and
a third diode, wherein
a cathode of the first diode is coupled to a first output end of the first DC/DC converter, a anode of the first diode is coupled to a first output end of the second DC/DC converter, a cathode of the second diode is coupled to the first output end of the first DC/DC converter by using the first relay switch, a anode of the second diode is coupled to a second output end of the second DC/DC converter, a cathode of the third diode is coupled to a second output end of the first DC/DC converter by using the second relay switch, a anode of the third diode is coupled to the first output end of the second DC/DC converter, the second output end of the first DC/DC converter is a first output end of the charging circuit, and the second output end of the second DC/DC converter is a second output end of the charging circuit;
the first relay switch and the second relay switch are open, so that the first DC/DC converter and the second DC/DC converter are connected in series; and
the first relay switch and the second relay switch are closed, so that the first DC/DC converter and the second DC/DC converter are connected in parallel.

5. The charging circuit according to claim 4, wherein the charging circuit further comprises a control circuit configured to:
when the first voltage is in the first threshold range, control the first relay switch and the second relay switch to connect the first DC/DC converter and the second DC/DC converter in series, and
when the first voltage is in the second threshold range, control the first relay switch and the second relay switch to connect the first DC/DC converter and the second DC/DC converter in parallel.

6. The charging circuit according to claim 2, wherein when the first relay switch is an alternating current relay switch, the charging circuit further comprises a first semiconductor device configured to protect the first relay switch coupled to the first semiconductor device in parallel.

7. The charging circuit according to claim 4, wherein when the first relay switch is an alternating current relay switch and the second relay switch is an alternating current relay switch, the charging circuit further comprises a first semiconductor device and a second semiconductor device, wherein
the first relay switch and the second relay switch are respectively coupled to the first semiconductor device and the second semiconductor device in parallel;
the first semiconductor device is configured to protect the first relay switch; and
the second semiconductor device is configured to protect the second relay switch.

8. The charging circuit according to claim 6, wherein the first semiconductor device is any one of an insulated gate bipolar transistor (IGBT), a metal-oxide-semiconductor (MOS) field-effect transistor, and a silicon controlled rectifier (SCR).

9. The charging circuit according to claim 7, wherein the second semiconductor device is any one of an IGBT, a MOS field-effect transistor, and a SCR.

10. The charging circuit according to claim 1, wherein a circuit structure of each of the first DC/DC converter and the second DC/DC converter is any one of:
a full-bridge inductor-inductor-capacitor (LLC) resonant circuit, a half-bridge LLC resonant circuit, a three-level LLC resonant circuit, a three-level full-bridge circuit, a phase-shift full-bridge circuit, an asymmetric half-bridge circuit, and a three-phase interleaved LLC resonant circuit.

11. A charging apparatus, comprising:
a charging circuit, comprising:
at least two groups of direct current (DC)/DC converters mutually coupled,
at least one group of relay switches configured to connect the at least two groups of DC/DC converters in series when a first voltage is in a first threshold range, and configured to connect the at least two groups of DC/DC converters in parallel when the first voltage is in a second threshold range, wherein the first voltage is a charging voltage of an electric vehicle, and
at least one diode configured to prevent a current of a storage battery in the electric vehicle from flowing back.

12. The apparatus according to claim 11, wherein when the charging circuit comprises two groups of DC/DC converters and one group of relay switches, the charging circuit comprises:
a first DC/DC converter,
a second DC/DC converter,
a first relay switch,
a first diode,
a second diode, and
a third diode, wherein
a cathode of the first diode is coupled to a first output end of the first DC/DC converter by using the first relay switch, a anode of the first diode is coupled to a first output end of the second DC/DC converter, a cathode of the second diode is coupled to the first output end of the first DC/DC converter, a anode of the second diode is coupled to a second output end of the second DC/DC converter, a cathode of the third diode is coupled to a second output end of the first DC/DC converter, a anode of the third diode is coupled to the first output end of the second DC/DC converter, the second output end of the first DC/DC converter is a first output end of the charging circuit, and the second output end of the second DC/DC converter is a second output end of the charging circuit.

13. The apparatus according to claim 12, wherein the charging circuit further comprises a control circuit configured to:
when the first voltage is in the first threshold range, control the first relay switch to connect the first DC/DC converter and the second DC/DC converter in series, and
when the first voltage is in the second threshold range, control the first relay switch to connect the first DC/DC converter and the second DC/DC converter in parallel.

14. The apparatus according to claim 11, wherein when the charging circuit comprises two groups of DC/DC converters and two groups of relay switches, the charging circuit comprises:
a first DC/DC converter,
a second DC/DC converter,
a first relay switch,
a second relay switch,
a first diode,
a second diode, and
a third diode, wherein
a cathode of the first diode is coupled to a first output end of the first DC/DC converter, a anode of the first diode is coupled to a first output end of the second DC/DC converter, a cathode of the second diode is coupled to the first output end of the first DC/DC converter by using the first relay switch, a anode of the second diode is coupled to a second output end of the second DC/DC converter, a cathode of the third diode is coupled to a second output end of the first DC/DC converter by using the second relay switch, a anode of the third diode is coupled to the first output end of the second DC/DC converter, the second output end of the first DC/DC converter is a first output end of the charging circuit, and the second output end of the second DC/DC converter is a second output end of the charging circuit;
the first relay switch and the second relay switch are open, so that the first DC/DC converter and the second DC/DC converter are connected in series; and
the first relay switch and the second relay switch are closed, so that the first DC/DC converter and the second DC/DC converter are connected in parallel.

15. The apparatus according to claim 14, wherein the charging circuit further comprises a control circuit configured to:
when the first voltage is in the first threshold range, control the first relay switch and the second relay switch to connect the first DC/DC converter and the second DC/DC converter in series, and
when the first voltage is in the second threshold range, control the first relay switch and the second relay switch to connect the first DC/DC converter and the second DC/DC converter in parallel.

16. The apparatus according to claim 12, wherein when the first relay switch is an alternating current relay switch, the charging circuit further comprises a first semiconductor device configured to protect the first relay switch coupled to the first semiconductor device in parallel.

17. The apparatus according to claim 14, wherein when the first relay switch is an alternating current relay switch and the second relay switch is an alternating current relay switch, the charging circuit further comprises a first semiconductor device and a second semiconductor device, wherein
the first relay switch and the second relay switch are respectively coupled to the first semiconductor device and the second semiconductor device in parallel;
the first semiconductor device is configured to protect the first relay switch; and
the second semiconductor device is configured to protect the second relay switch.

18. The apparatus according to claim 16, wherein the first semiconductor device is any one of an insulated gate bipolar transistor (IGBT), a metal-oxide-semiconductor (MOS) field-effect transistor, and a silicon controlled rectifier (SCR).

19. The apparatus according to claim 17, wherein the second semiconductor device is any one of an IGBT, a MOS field-effect transistor, and a SCR.

20. The apparatus according to claim 11, wherein a circuit structure of each of the first DC/DC converter and the second DC/DC converter is any one of:
a full-bridge inductor-inductor-capacitor (LLC) resonant circuit, a half-bridge LLC resonant circuit, a three-level LLC resonant circuit, a three-level full-bridge circuit, a phase-shift full-bridge circuit, an asymmetric half-bridge circuit, and a three-phase interleaved LLC resonant circuit.
